(19) United States
(12) Patent Application Publication
(10) Pub. No.: US 2015/0352890 A1
(43) Pub. Date: Dec. 10, 2015

(54) WRITING INSTRUMENT WITH CUSTOMIZABLE ADD-ON BEADS

(71) Applicant: Pen Palz Inc., Tustin, CA (US)

(72) Inventors: TOMMY LE, Tustin, CA (US); Hoi Diep, Tustin, CA (US)

(21) Appl. No.: 14/736,230

(22) Filed: Jun. 10, 2015

Related U.S. Application Data
(60) Provisional application No. 62/010,416, filed on Jun. 10, 2014.
(60) Provisional application No. 62/010,419, filed on Jun. 10, 2014.

(51) Int. Cl. B43K 8/00; B43K 29/007; B43K 8/02; B43K 19/02; B43K 19/00

(52) U.S. Cl. CPC B43K 8/003; B43K 19/02; B43K 19/003; B43K 8/02; B43K 29/007

(57) ABSTRACT

A customizable writing instrument includes a transparent, elongated hollow barrel-style body including an opening in at least one end and a raised extrusion on an inner surface of said body; a writing element disposed within the body, a plurality of beads located within the body, wherein the beads include a central opening and are disposed such that the writing element passes through the central opening resulting in the beads being placed in a stacked arrangement substantially parallel to a length of the writing element. A side of each of the beads includes at least one groove that is adapted to mate with a raised extrusion in order to hinder rotation of the bead around the writing element. The body is sized such that an outer edge of the beads are substantially flush with an inner surface of the body and has sufficient space to contain simultaneously both a writing element and the beads.

### PRIORITY

The present application claims prior of U.S. Provisional application Ser. No. 62/010,416, which was filed on Jun. 10, 2014.

### BACKGROUND OF THE INVENTION

1. Field of the Invention

The present invention relates to the general art of writing instruments, and to the particular field of customizable decorative writing instruments.

2. General Background and State of the Art

Humans have used instruments to communicate written messages for thousands of years, dating back to the first paintings sketched on cave walls. The advent of paper necessitated devices that would allow permanent ink to be controllably etched. Ancient Egyptians used reeds with tips sharpened into a nib. With advances in paper technology, finer tips could be utilized, starting with quills and culminating in the eponymous ballpoint, an instrument that is a self-contained writing unit with the nib and ink well contained in a single body.

The progress in writing technology has corresponded with similar progress in artistic endeavors. Communication can take the form of explicitly worded messages, but also manifest in visual elements and decorations. Thus, the same cave drawings could be decorative or communicative depending on the intent of the originator and the understanding of the viewer. In this manner humankind has been influencing a customization of the physical components of the world.

Even utilitarian tools and articles have received this treatment of decorative customization. For instance, Native Americans and other indigenous people have used beads for decorative purposes on clothing, shoes, and as works of art. Beads are considered to be among the oldest types of jewelry. These beads, small and usually round objects, were made of glass, wood, ceramics, precious metals, gems, stone, plastic, or the like, and have a hole through the center in order to be threaded or strung with other objects. This allows these items to be customized for identification or just pure decoration.

Pens are often the source of decoration, but pens themselves are viewed exclusively as utilitarian items, removed from accessorization. They are manufactured en masse, and received by the user as-is. This allows very little opportunity for the user to natively change the appearance of the pen. This can be necessitated for any number of reasons: a sports fan that wants to display the emblem of their favorite team for each changing season, a business owner that wants a unique way to advertise multiple and differing phrases, or a schoolchild that wants to share a special daily message with a friend across the room.

### INVENTION SUMMARY

The above-discussed disadvantages in the prior art are overcome by the present invention, which is related to a writing instrument that is customizable by the user, comprising of a pen body with an insertable writing element and beads. The writing element, which is comprised of a tube filled with one of the many known marking means, such as ink or pencil lead, has an exterior diameter that acts as a central axis for the beads, which are slid onto the writing element in an order and number decided by the user. The writing element is then attached to the pen body, which is comprised of a clear barrel with an inner diameter that matches the outer diameter of the beads. If there is a need to change the beads, the user may detach the writing element, change the beads, and reinsert the writing element into the elongated barrel. If the writing medium is exhausted and can be replaced, the beads can be mounted on the replacement element in similar fashion.

Beads may be clear or of various colors, and may display symbols, letters, pictures, etc. For example, if the user is a fan of a sports team, he/she may customize the writing instrument to display the name or logo of the team. Another example would be to customize the instrument to state the name of the user or a loved one.

Certain beads may have characters that can be combined with other beads within the barrel to produce a cohesive statement. For these beads, the coherence of the message is determined by the axial alignment, i.e., the same face of all of the beads must be facing in the same direction at once for the message to be properly read. The present invention can also contain an anti-rotation system, compromised of an extrusion on the bead that slides into a congruent groove in the barrel, locking the beads against axial rotation against the central axis. This allows certain beads to rotate freely while restricting the rotation of beads with the extrusion. A reversal of features is also contemplated for the anti-rotation system. A tongue or extrusion can be formed on the inner surface of the barrel. This structure mates with a groove or slot that is formed on one side of each of the beads. It yet another alternative, some (or all) of he beads can omit the locking structure, thereby permitting them to rotate freely around the central axis inside the barrel. This may be desirable to the user of the device from an functional or aesthetic viewpoint.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

These and other features of this invention will be best understood by reference to the following detailed description of a preferred embodiment of the invention, taken in conjunction with the accompanying drawings, in which:

FIG. 1 is a plan view of the hollow body of the writing instrument.

FIG. 2 is a plan view of the writing element filled with a marking mean.

FIG. 3 is a plan view of the writing instrument body holding a writing element without any beads.

FIG. 4 shows an embodiment of the invention containing one combination of bead indicia.

FIG. 5 shows an alternative embodiment of bead indicia.

FIG. 6 shows an alternative embodiment of writing instrument where there is no see through barrel.

### DETAILED DESCRIPTION OF THE PREFERRED EMBODIMENTS

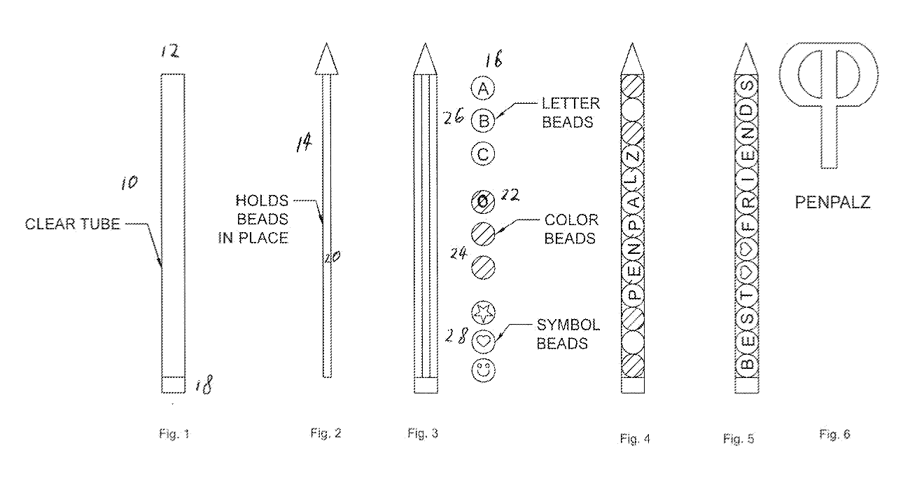

FIG. 1 shows a plan view of the hollow body of the writing instrument. The body has a hollow cylindrical shape, which is a preferred embodiment to make it easier to use as a writing instrument. The elongated body may have different shapes, such as oval, hexagonal, octagonal, etc. The body is preferred to be of a see through material so that the beads may be visible. One side of the body 10 has an opening 12 for receiving a writing element 14 and the decorative element 16. In a preferred embodiment the decorative element is a bead. The other end of the body is usually closed by an end cap 18 to prevent the beads from falling out. The cap may be configured to be used as an eraser, highlighter or have some other functionality.

FIG. 2 shows a plan view of the writing element 14 filled with a marking mean 20.

In the present embodiment, the writing element is a tube and is filled with ink 20. The writing element may have different shapes and may be filled with one of many known marking means such as ink-based elements, fluid based elements, pigment, crayon, etc.

The writing element also functions as an axis for the beads 16. A bead has a hole 22 through it. The writing element is inserted through the hole 22 so that it will function as an axis for the beads. Beads 16 may be made of glass, wood, stone, plastic or the like. Beads 16 may be clear or of various colors, may display symbols, letters, pictures, etc.

FIG. 3 is a plan view of the writing instrument body holding a writing element without any beads. The body 10 of the writing instrument frictionally holds the writing element 14.

FIG. 4 shows an embodiment of the invention containing one combination of bead indicia. The embodiment shows use of colorful beads 24 and letter beads 26. FIG. 5 shows an alternative embodiment of bead indicia where letter 26 and symbol 28 beads are used. User may use combination of any bead indicia based on his/her taste and needs.

While the specification describes particular embodiments of the present invention, those of ordinary skill can devise variations of the present invention without departing from the inventive concept.

We claim:

1. A customizable writing instrument comprising:
a writing element;
a hollow container that forms the body of the writing instrument substantially enclosing said writing element;
at least one decorative element; and
means for connecting said decorative element to said writing element and means for aligning said decorative element with respect to said hollow container.

2. The writing instrument of claim 1, wherein said writing element comprises a tube that includes a marking means such as ink, highlighter fluid, pencil lead, or crayon, and is attached to a conical cap, with a narrow end of said cap having a hole that allows for a component to extend out that transfers said marking means onto a medium, and the wide end of the cap having the capability to attach to said body.

3. The writing instrument of claim 1, wherein said body comprises a transparent, elongated hollow barrel-style body.

4. The writing instrument of claim 1, further comprising at least one opening on said body to permit removal of said writing element and allow for insertion of said decorative element into said body of said writing instrument.

5. The writing instrument of claim 1, wherein said decorative element comprises of beads that include a central opening.

6. The writing instrument of claim 1, wherein said means for connecting said decorative item to said writing element consists of a central opening in said decorative item disposed such that said writing element passes through said central opening resulting in said decorative items being placed in a stacked arrangement substantially parallel to a length of said writing element.

7. The writing instrument of claim 1 wherein said means for aligning provides for fixing the alignment of the decorative elements against axial rotation, such that a desired face of said decorative element can be displayed at a desired orientation within said body of the writing instrument.

8. The writing instrument of claim 1, further comprising a means for fixing the decorative items' alignment against rotation within the writing instrument, comprising:
An extruded tongue on the inside surface of the body wall; and
A groove on the decorative item that is substantially congruent to the tongue on the inside surface of the body that will allow the decorative item to slide substantially parallel to the central axis created by the writing surface, but prevent axial rotation around the writing element such that the decorative item's alignment will be secured as viewed through the body wall.

9. The writing instrument of claim 1, further comprising a means for fixing the decorative item's alignment against rotation within the writing instrument, comprising:
A groove on the inside surface of the body wall; and
An extruded tongue on the decorative item that is substantially congruent to the groove on the inside surface of the body that will allow the decorative item to slide substantially parallel to the central axis created by the writing surface, but prevent axial rotation around the writing element such that the decorative items' alignment will be secured as viewed through the body wall.

10. A customizable writing instrument comprising:
a writing element;
a hollow container that forms the body of the writing instrument substantially enclosing said writing element;
a plurality of beads disposed over said writing element and within said body; and
tongue and groove means for aligning said decorative element with respect to said body.

11. The writing instrument of claim 10, wherein said writing element comprises a tube that includes a marking means such as ink, highlighter fluid, pencil lead, or crayon, and is attached to a conical cap, with a narrow end of said cap having a hole that allows for a component to extend out that transfers said marking means onto a medium, and the wide end of the cap having the capability to attach to said body.

12. A customizable writing instrument comprising:
a transparent, elongated hollow barrel-style body including an opening in at least one end and a raised extrusion on an inner surface of said body;
a writing element disposed within said body;
a plurality of beads located within said body,
wherein said beads include a central opening and are disposed such that said writing element passes through said central opening resulting in said beads being placed in a stacked arrangement substantially parallel to a length of said writing element; and further wherein a side of each of said beads includes at least one groove that is adapted to mate with said raised extrusion in order to hinder rotation of said bead around said writing element
wherein said body is sized such that an outer edge of said beads are substantially flush with an inner surface of said body and has sufficient space to contain simultaneously both a writing element and said beads.

13. The writing instrument of claim 12, wherein said writing element comprises a tube that includes a marking means such as ink, highlighter fluid, pencil lead, or crayon, and is attached to a conical cap, with a narrow end of said cap having a hole that allows for a component to extend out that transfers said marking means onto a medium, and the wide end of the cap having the capability to attach to said body.

14. The writing instrument of claim 12, further comprising a gripping surface on the outside of said body to enhance grip while utilizing the writing instrument.
